(19) United States
(12) Patent Application Publication
(10) Pub. No.: US 2005/0086402 A1
(43) Pub. Date: Apr. 21, 2005

(54) [PORTABLE MICRO-CONTROL DEVICE AND CONTROLLER]

(76) Inventor: Kuo-Kaung Keng, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,869

(22) Filed: Jan. 20, 2004

(30) Foreign Application Priority Data
Oct. 17, 2003 (TW) 92128827

(51) Int. Cl. G06F 13/12

(52) U.S. Cl. 710/62

(57) ABSTRACT

A portable micro-control device and a controller are provided. The micro-control device comprises a viewer, an input device, a power supply and a controller. The controller further comprises a mini-root hub, a power module, a local buffer module, an output controller, an input controller and a processor. The portable micro-control device uses a simple processor operating on a simple operating system. Therefore, a user can easily copy, move, backup, delete, edit or format data on the multi-media devices and storage devices plugged into the portable micro-control device.

### CROSS REFERENCE TO RELATED APPLICATIONS

This application claims the priority benefit of Taiwan application serial no. 92128827, filed Oct. 17, 2003.

### BACKGROUND OF INVENTION

1. Field of the Invention

The present invention relates to a portable data processing device. More particularly, the present invention relates to a portable micro-control device that can connect with an input/output slave device.

2. Description of the Related Art

As technologies continue to advance, size of communication products is getting smaller and smaller. As the size of communication products is reduced, many types of portable multi-media devices are now out in the market including, for example, MP3s, recording pens, digital cameras and digital camcorders. Furthermore, advanced IC fabrication methods have also brought about a large drop in the size and the price of various slave type external storage media such as the flash disks, flash memory cards, the external hard drives, the external rewritable CD/DVD drives and so on.

Among the conventional techniques, few of the multi-media devices permit a direct slave of any external storage media so that a bidirectional data access, backup or file exchange operation can be carried out between the multi-media device and the external storage media. Typically, a storage media compatible with a particular brand of multi-media device has to be purchased if backup data needs to be stored. However, repeated purchase of a particular type of compatible storage media is a burden as well as a waste to the users because these storage media can only be used in one type of multi-media device. Hence, full utilization of the storage media is impossible. To increase overall utilization of the storage media, the multi-media device is connected to a computer and a data exchange operation is performed from time to time. Nevertheless, a computer is expensive and not so easy to carry even for the so-called “portable computer”. In addition, the computer not only consumes a lot of power but also uses a large and complicated operating system.

### SUMMARY OF INVENTION

Accordingly, at least one objective of the present invention is to provide an inexpensive, power-saving and portable micro-control device. The portable micro-control device serves as a bridge linking a multi-media device and a storage media so that data can be copied, moved, backup, deleted, edited and formatted between the multi-media device and the storage media.

At least a second objective of this invention is to provide a controller that can be used in the aforementioned portable micro-control device for lowering power consumption, simplifying operation and improving portability.

To achieve these and other advantages and in accordance with the purpose of the invention, as embodied and broadly described herein, the invention provides a portable micro-control device. The portable micro-control device is able to accommodate a plurality of input/output slave devices. The micro-control device comprises a viewer, an input device, a power supply and a controller. The controller further comprises at least two input/output (I/O) ports. The plurality of input/output ports is used for connecting with the input/output slave devices. The viewer displays status & data and the input device receives work command signals. In addition, the power supply provides all the power needed to operate the micro-control device. When the input/output slave devices are inserted into the micro-control device, the viewer of the micro-control device shows all the stored and related data inside various input/output slave devices. According to the work command signal, operations on the stored data within these input/output slave devices are performed.

According to one embodiment of this invention, the viewer of the micro-control device is a liquid crystal display. The input device of the micro-controller device includes an up-pointing key, a down-pointing key, a left-pointing key, a right-pointing key and at least an enter key. The input/output ports of the micro-control device can be a universal serial bus (USB), a serial ATA (SATA) or other types of input/output port.

This invention also provides a controller for a portable micro-control device. The controller comprises a plurality of input/output ports, a mini-root hub, an output controller, a power module, a local buffer module, an input controller, a direct memory access (DMA) controller and a processor. The power module provides power to the controller and the output controller drives an viewer. Furthermore, the input controller can receive work command signals from an input device. The aforementioned input/output ports can connect with a plurality of input/output slave devices and the mini-root hub is coupled to the input/output ports for transmitting data between these input/output slave devices. The local buffer module is coupled to the mini-root hub for holding data in transition temporarily. The processor is coupled to the output controller, the input controller and the local buffer module. According to the work command signal, the processor operates on the data provided by the input/output slave device.

Through the micro-control device and controller of this invention, connection to various I/O port slave devices is provided. The micro-control device deploys simple processor architecture and operating system and uses the minimal number of key-in buttons. Furthermore, through a standard built-in initializing sequence set up inside the micro-control device, data within any one of the I/O slave devices connected to the micro-control device can be copied, transferred, backup, deleted, edited or formatted rapidly.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing functional relationships between a portable micro-control device and a controller according to one preferred embodiment of this invention.

FIG. 2 is a flowchart showing the standard initialization sequence of the micro-control device and controller system according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

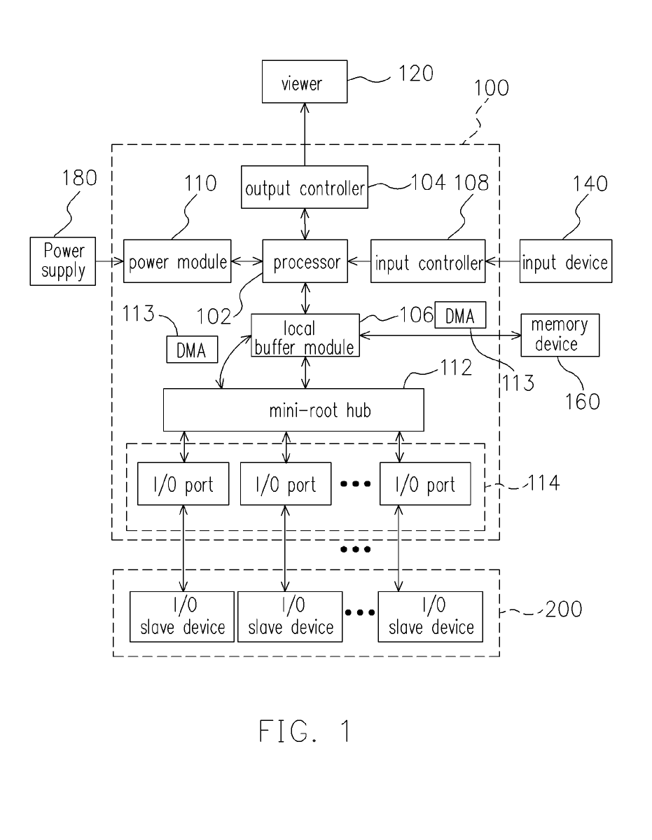

FIG. 1 is a block diagram showing functional relationships between a portable micro-control device and a controller according to one preferred embodiment of this invention. As shown in FIG. 1, the portable micro-control device comprises a viewer 120, an input device 140, a power supply 180 and a controller 100. The controller 100 further comprises a processor 102, an output controller 104, a local buffer module 106, an input controller 108, a power module 110, a mini-root hub 112, a direct memory access (DMA) controller 113 and a plurality of input/output ports 114. The micro-control device also has a number of connectors for engaging various input/output slave devices 200 to the input/output ports 114 inside the controller 100.

Inside the controller 100, the processor 102 is coupled to the output controller 104, the input controller 108 and the power module 110. The processor 102 accesses the input/output slave devices 200 via the local buffer module 108, the mini-root hub 112 and the input/output port 114. The output controller 104 is coupled to the viewer 120 and the input controller 108 is coupled to the input device 140. The local buffer module 106 may couple to a memory device 160. The input/output ports 114 are connected to various input/output slave devices 200 and the power module 110 is connected to the power supply 180.

As shown in FIG. 1, the output controller 104 inside the controller 100 drives the viewer 120, that is, the liquid crystal display in this embodiment. The input controller 108 inside the controller 100 drives the input device 140. The processor 102 controls the exchange of data and any communication at the interfaces. Here, a processor having an 8-bit or 16-bit architecture can be used. Even if a processor with higher bit count is used, a simple architecture is required. The power module 110 is connected to the power supply 180. The power supply 180 can be a group of batteries or can be a unit connected to a power source. The power supply 180 provides power to the micro-control device as well as various connected input/output slave devices 200. The local buffer module 106 serves as an internal data buffer. The mini-root hub 112 is a bridge for supporting data transmission to or from the input/output ports 114. In addition, the controller 100 at least includes two input/output slave devices 200. The direct memory access (DMA) controller 113 inside the controller 100 facilitates a direct access of the data within the memory device 160.

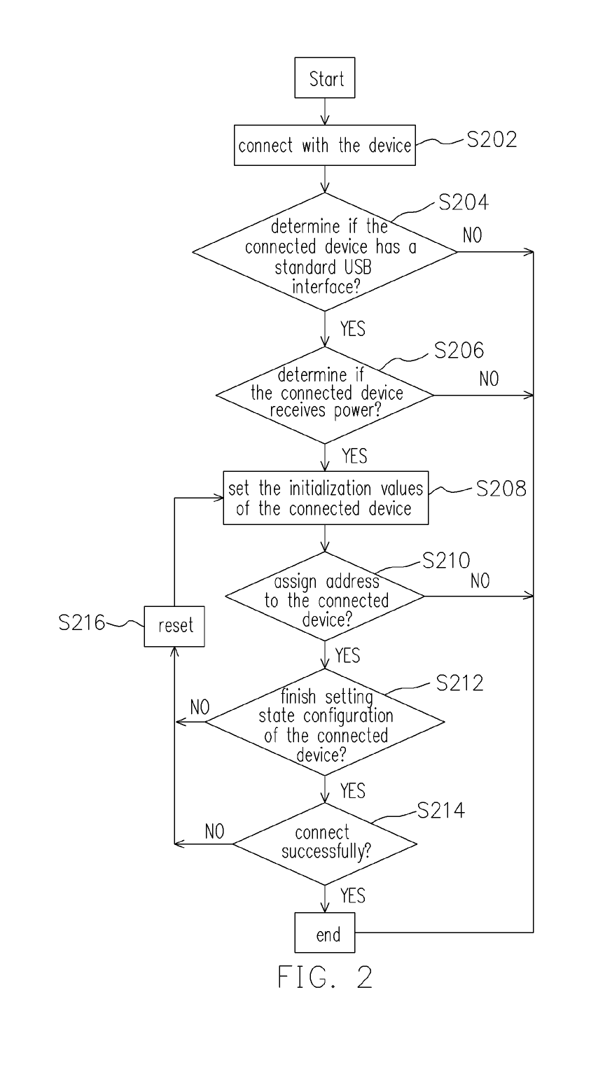

FIG. 2 is a flowchart showing the standard initialization sequence of the micro-control device and controller system according to one preferred embodiment of this invention. In this embodiment, the input/output ports 114 are universal serial bus (USB) ports, for example. First, after plugging a first device into the micro-control device (S202), that is, connecting with USB slave device, a standard initialization sequence is triggered to produce a proper connection. Thereafter, the first device is checked to determine if the first device has a USB standard interface (S204). If the first device is not a standard USB interface, the flow ends. Conversely, if the first device is a standard USB interface, the first device is checked to determine if power is provided (S206). If the first device does not receive any power, the flow also ends. Conversely, if the first device has obtained power, the initialization values for the device are set (step S208).

After setting the initialization values of the first device (step S208), address of the first device is assigned (step S210). If the assignment of an address for the first device fails, the flow ends. Conversely, if the assignment is successful, the first device is checked to determine if setup configuration is completed (step S212). In step S212, if the setup configuration of the first device is incomplete, return to step S208. On the contrary, if the setup configuration of the first device is completed, the first device is assessed to determine if the connection with the micro-control device is successful (step S214). In step S214, if the connection with the micro-control device is successful, the standard initialization sequence has been completed so that the connection with other devices may commence. However, if the connection with the micro-control device fails, control is returned to step S208 via a resetting step S216 and resume the re-initialization procedure again.

The micro-control device according to this invention can be applied to a USB device such as a USB supported digital camera and a mobile disk drive. After connecting the digital camera and the mobile disk drive to the micro-control device, the built-in standard initialization sequence within the controller 100 will determine if the connection is successful. If the connection of the micro-control device with the digital camera and the mobile disk is successful, states of the two connected devices can be gleaned from the viewer 120. Thereafter, a user may input work command signals into the micro-control device through the input device 140. In other words, through the “up”, “down”, “right”, “left” and “enter” buttons, data can be copied, transferred, backup, deleted, edited or formatted. The work command signals pass through the input controller troller 108 and transmits to the processor 102. According to the work command signals, the processor 102 processes the data inside the digital camera and the mobile disk drive by retrieving the data from the devices via the mini-root hub 112 and transferring the data to the local buffer module 106, which serves as a temporary storage area. To speed up the transfer of data, a direct memory access (DMA) controller 113 may be used. In this embodiment, if the mini-root hub 112 supports the USB, data is transmitted through the mini-root hub 112 in the bulk mode. Furthermore, the local buffer module 106 may connect with an external memory unit 160 to expand memory storage capacity.

In the aforementioned embodiment, after backing up the photographic data inside the digital camera to a mobile disk drive, the cleared storage area inside the digital camera can be reused so that more photos can be taken with the digital camera. Similarly, the same procedure can be applied to a MP3, a recording pen, a camcorder and so on. The micro-control device may even serve as a platform for exchanging data between two mobile disk drives.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A portable micro-control device for inserting a plurality of input/output slave devices, the micro-control device comprising:
viewer for displaying an output data;
an input device for receiving a work command signal;
a power supply for providing power to the micro-control device; and
a controller coupled to the viewer and the input device, wherein the controller at least comprises a plurality of input/output ports for connecting with the input/output slave devices,
wherein the viewer in the micro-control device displays the stored data and related data inside the input/output slave devices once the input/output slave devices are inserted into the micro-control device, and operates on the data stored inside the input/output slave devices according to a work command signal.

2. The micro-control device of claim 1, wherein the input/output ports are universal serial bus (USB) ports.

3. The micro-control device of claim 1, wherein the viewer comprises a liquid crystal display.

4. The micro-control device of claim 1, wherein the input device has a set of buttons including an “up” button, a “down” button, a “right” button, a “left” button and at least an “enter” button.

5. The micro-control device of claim 1, wherein after a first device has been inserted into one of the input/output ports, the controller determines if the first device matches the input/output standard, then determines if the first device receives any power, then sets the initialization values of the first device, then assigns memory address to the first device, then set the state configuration of the first device and finally determines if the first device is successfully connected.

6. The micro-control device of claim 1, wherein the standard operation includes copying, transferring, backing up, deleting, editing or formatting the data stored inside the input/output slave devices.

7. A controller for a portable micro-control device, comprising:
power module for providing electrical power;
a plurality of input/output ports for connecting with a plurality of input/output slave devices;
a mini-root hub coupled to the input/output ports for transmitting the data stored inside the input/output slave devices;
a local buffer module coupled to the mini-root hub for holding some of the data temporarily;
n output controller for driving a viewer;
an input controller for receiving a work command signal from an input device; and
a processor coupled to the output controller, the input controller and the local buffer module, wherein the processor performs an operation on the data stored inside the input/output slave devices according to the work command signal.

8. The controller of claim 7, wherein the input/output ports are universal serial bus (USB) ports and the mini-root hub supports the universal serial bus.

9. The controller of claim 8, wherein the mass data transmits in a bulk mode.

10. The controller of claim 7, wherein the input/output ports include serial ATA ports.

11. The controller of claim 7, wherein the local buffer module is connected to an external memory device.
